(19) United States
(12) Patent Application Publication
(10) Pub. No.: US 2025/0328550 A1
(43) Pub. Date: Oct. 23, 2025

(54) ENTITY RELATIONSHIP DIAGRAM GENERATION FOR DATABASES

(71) Applicant: Western Digital Technologies, Inc., San Jose, CA (US)

(72) Inventors: Lay Chuan Lim, Seberang Perai Selatan (MY); Sunny Chan, Seberang Perai Selatan (MY); Seng Wee Saw, Seberang Perai Selatan (MY); Sarmla Kolasingam, Seberang Perai Selatan (MY)

(21) Appl. No.: 18/640,346

(22) Filed: Apr. 19, 2024

(51) Int. Cl. G06F 16/28; G06F 16/21

(52) U.S. Cl. CPC G06F 16/288; G06F 16/212

(57) ABSTRACT

A database system includes at least one data storage device storing at least one database and one or more processors configured to identify, from Structured Query Language (SQL) commands received for the at least one database, entities of the SQL commands, attributes of the entities, and relationships between the entities. The identified entities, attributes, and relationships are translated into a visual markup language code using a Large Language Model (LLM). In some aspects, the LLM or another LLM may be provided with the SQL commands to identify the entities, attributes, and relationships. An Entity Relationship Diagram (ERD) is generated or updated for the at least one database based on the translated visual markup language code. In other aspects, at least two of the identified entities, attributes, or relationships are merged for representation in the ERD.

### BACKGROUND

Many businesses generate and accumulate large amounts of data that are stored in tables of databases. Some studies find that employees spend nearly twenty percent of their work week looking for internal information or tracking down colleagues who can help them find the information they need for specific tasks. For example, to retrieve particular information from a database, a user of the database or a data engineer may need to consult with other colleagues, such as domain experts and database administrators, or may need to investigate the database and attempt to interpret the data through experiments.

A database Entity Relationship Diagram (ERD) that shows how different entities or tables in the database relate to each other can help in finding information. However, creating and maintaining an ERD for one or more databases typically requires a significant ongoing effort by domain experts or those with specific knowledge concerning the data stored in the database. Although there are some software tools that can help construct ERDs for databases, such tools rely on the metadata and schema information for the tables in the database that was documented by the creators of the tables. This metadata and schema information is not mandatory for operation of the database and is therefore often omitted. It is also very unlikely that the metadata and schema information is updated as changes are made to the database over time. As a result, the software tools for constructing ERDs for databases are limited by the lack of current metadata and schema information and still require significant effort from domain experts to create and maintain an ERD.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 is a block diagram of an example database system configured to generate an Entity Relationship Diagram (ERD) for at least one database according to one or more embodiments.

FIG. 2 is an example of a log of Structured Query Language (SQL) commands according to one or more embodiments.

FIG. 3 illustrates the identification by a Large Language Model (LLM) of entities, attributes, and a relationship between the entities included in an SQL command according to one or more embodiments.

FIG. 4 is an example of the SQL command of FIG. 3 translated into a visual markup language code according to one or more embodiments.

FIG. 5 is an example of the merging of two visual markup language codes for two respective SQL commands according to one or more embodiments.

FIG. 6A is a first part of an example illustrating the merging of the SQL commands from the log of FIG. 2 as represented by ERDs according to one or more embodiments.

FIG. 6B is a second part of the example of FIG. 6A illustrating the merging of the SQL commands from the log of FIG. 2 as represented by ERDs according to one or more embodiments.

FIG. 6C is a third part of the example illustrating the merging of the SQL commands from the log of FIG. 2 as represented by ERDs according to one or more embodiments.

FIG. 7 is an example of a final ERD after merging the SQL commands from the log of FIG. 2 according to one or more embodiments.

FIG. 8A is an example of a SQL query command that provides an entity relationship and a corresponding ERD according to one or more embodiments.

FIG. 8B is an example of a nested SQL query command that provides an entity relationship and a corresponding ERD according to one or more embodiments.

FIG. 9 is a flowchart for a database diagram process according to one or more embodiments.

FIG. 10 is a flowchart for a log filtering process according to one or more embodiments.

FIG. 11A is a first part of a flowchart for a merge process according to one or more embodiments.

FIG. 11B is a second part of the flowchart for the merge process from FIG. 9A according to one or more embodiments.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

### Example System Environments

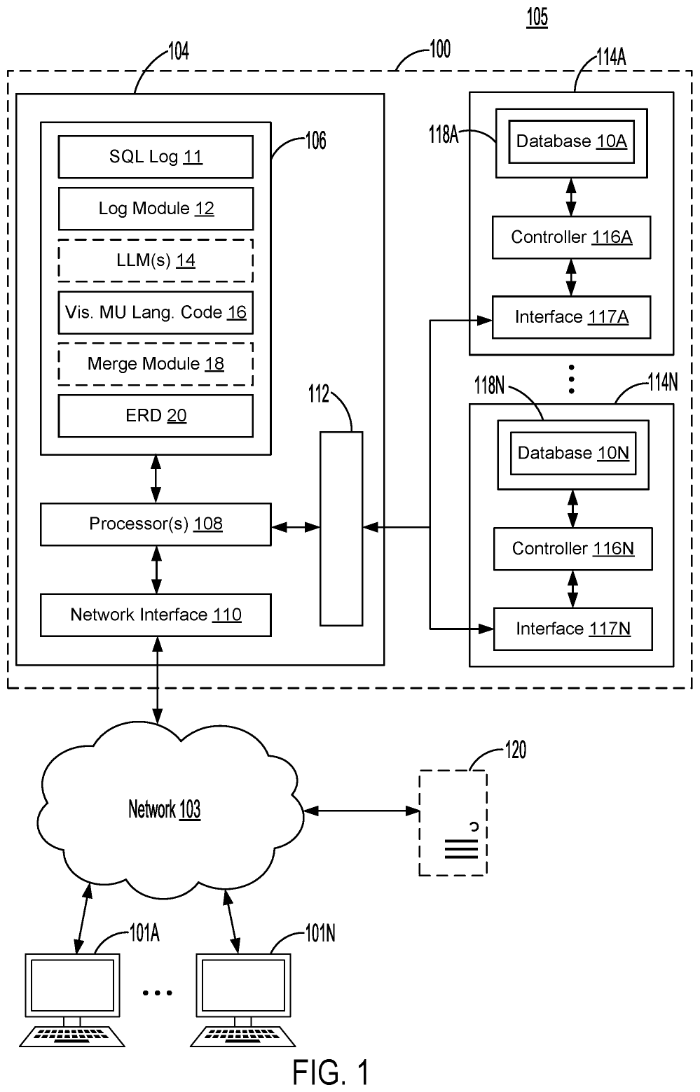

FIG. 1 is a block diagram of database system 105 that can generate an Entity Relationship Diagrams (ERD) for at least one database stored in storage system 100 according to one or more embodiments. As shown in FIG. 1, database system 105 includes storage system 100, optional cloud server 120, and clients 101 in communication with storage system 100 via network 103.

Storage system 100 includes server 104 and DSDs 114A to 114N that each store respective portions of at least one database 10. In some implementations, server 104 and DSDs 114 can form, for example, one or more storage servers, such as a Network Attached Storage (NAS) or Storage Area Network (SAN), or may form a data center, or a portion of a data center. In other implementations, server 104 and DSDs 114 may not be co-located and may be in different geographical locations.

In the example of FIG. 1, clients 101A to 101N use network 103 to access storage system 100 via server 104. Clients 101A to 101N may retrieve data from or store data in DSDs 114 of storage system 100. In this regard, different users may access the data stored in the at least one database 10 stored in DSDs 114. Network 103 can include, for example, a Local Area Network (LAN) or a Wide Area Network (WAN), such as the internet.

Server 104 includes one or more processors 108, network interface 110, one or more local memories 106, and storage interface 112. Processor(s) 108 can include, for example, circuitry such as one or more Central Processing Units (CPUs), Graphics Processing Units (GPUs), microcontrollers, Digital Signal Processors (DSPs), Application-Specific Integrated Circuits (ASICs), Field Programmable Gate Arrays (FPGAs), hard-wired logic, analog circuitry and/or a combination thereof. In some implementations, processor(s) 108 can include a System on a Chip (SoC) that may be combined with one or more memories 106 of server 104, network interface 110 and/or storage interface 112. In the example of FIG. 1, processor(s) 108 execute instructions, such as instructions from log module 12, one or more Large Language Models (LLM(s)) 14, merge module 18, an operating system of server 104, or other applications executed by server 104.

As shown in FIG. 1, server 104 can communicate with DSDs 114A to 114N using storage interface 112 via a bus or network, which can include, for example, a Compute Express Link (CXL) bus, Peripheral Component Interconnect express (PCIe) bus, a LAN, or a WAN, or another type of bus or network. In this regard, storage interface 112 can include a network interface card in some implementations. In some examples, server 104 can include software for controlling communication with DSDs 114, such as a device driver of an operating system of server 104.

In this regard, network interface 110 provides communication between server 104 and network 103. Network interface 110 can include a network interface card in some implementations. In other implementations, server 104 may also communicate with DSDs 114 via network 103 instead of using a dedicated storage interface 112. In such implementations, storage interface 112 may be omitted in favor of using network interface 110 to communicate with DSDs 114.

In the example of FIG. 1, server 104 includes its own local memory or memories 106, which can include, for example, a Dynamic Random Access Memory (DRAM), Static Random Access Memory (SRAM), Magnetoresistive RAM (MRAM) or other type of Storage Class Memory (SCM), or other type of solid-state memory. While the description herein refers to solid-state memory generally, it is understood that solid-state memory may comprise one or more of various types of memory devices such as flash integrated circuits, NAND memory (e.g., Single-Level Cell (SLC) memory, Multi-Level Cell (MLC) memory (i.e., two or more levels), or any combination thereof), NOR memory, EEPROM, Chalcogenide RAM (C-RAM), Phase Change Memory (PCM), Programmable Metallization Cell RAM (PMC-RAM or PMCm), Ovonic Unified Memory (OUM), Resistive RAM (RRAM), Ferroelectric Memory (FeRAM), MRAM, 3D-XPoint memory, and/or other discrete Non-Volatile Memory (NVM) chips, or any combination thereof.

As shown in FIG. 1, memory or memories 106 of server 104 store data such as Structured Query Language (SQL) log 11, visual markup language code 16, and ERD 20. As discussed in more detail below, SQL commands from SQL log 11 and visual markup language code 16 can be used by processor(s) 108 to generate or update an ERD (e.g., ERD 20) for the database or databases 10 stored in DSDs 114.

In addition, memory or memories 106 of server 104 store computer-executable instructions or portions thereof in the example of FIG. 1, such as log module 12, one or more optional LLM(s) 14, and optionally, merge module 18. The dashed outline for LLM(s) 14 in FIG. 1 indicates that LLM(s) 14 may alternatively be located outside of server 104, such as at optional cloud server 120, which is also shown with a dashed outline in FIG. 1 to indicate that it may not be included in some implementations. In implementations where LLM(s) 14 are performed at cloud server 120, the one or more LLMs 14 can be provided as a cloud service to server 104 via network 103.

As discussed in more detail below, log module 12 stores SQL commands received from clients 101 for database(s) 10 in SQL log 11, and one or more LLM(s) 14 can be used by server 104 to perform at least one stage of generating or updating ERD 20. The SQL commands can be executed as they are received or in real-time during a first time period. At a later time period, the SQL commands in the log, or a portion thereof, can be used to generate and/or update an ERD, which may be performed in batches in some implementations.

In some cases, a single, a multitask LLM 14 may perform at least two stages of generating or updating ERD 20 that can include a first stage of identifying the entities, attributes, and relationships, a second stage of translating the identified entities, attributes, and relationships into a visual markup language code, and a third stage of merging the entities, attributes, and relationships. LLMs, such as ChatGPT developed by OpenAI, are Artificial Intelligence (AI) models that can process textual queries to respond with natural language or a programming language. LLMs are typically trained using large amounts of text and can be used for a wide variety of tasks, including, for example, translation, writing, and question answering.

In the first stage of generating or updating ERD 20, the entities of the SQL commands from SQL log 11 are identified, such as certain tables referenced in the SQL commands, together with the attributes of the entities, such as columns of the tables referenced in the SQL commands. Relationships between the entities in the SQL commands are also identified, such as commands to join portions of different tables at particular columns or query commands that relate the columns, for example. This first stage may be performed by an LLM 14 at server 104 or may be performed by cloud server 120 by providing the SQL commands to an LLM executing at cloud server 120.

In the second stage of generating or updating ERD 20, the identified entities, attributes, and relationships from the SQL commands are translated into visual markup language code, such as visual markup language code 16 in FIG. 1. An example of a visual markup language is PlantUML, which can enable the creation of a diagram from code using, for example, a PlantUML editor that may be accessed online by server 104 or executed locally by server 104 to generate or update ERD 20. The translation into the visual markup language code can be performed by an LLM 14 at server 104 or may be performed by cloud server 120 that executes an LLM.

In the third stage or merging stage, the translated visual markup language code or a list of entities, attributes, and relationships may be used to merge common entities from different SQL commands into a single entity. The merging may also summarize different relationships from SQL commands in a single visual markup language code or a single list of entities, attributes, and relationships. The attributes of common entities among the SQL commands can be joined, while removing or not duplicating entities, attributes, and relationships that appear in the SQL commands.

In some implementations, the merging stage may take place before translating the identified entities, attributes, and relationships into the visual markup language code, such as by merging at least two of the identified entities, attributes, or entity relationships from the SQL commands before translating the entities, attributes, and relationships into the visual markup language code. In other implementations, the merging stage may take place after translating the identified entities, attributes, and relationships into the visual markup language code, such as by merging the entities, attributes, and relationships from separate codes or separate ERDs created for each SQL command after translating the identified entities into the visual markup language code. In some cases, there may not be any common entities or relationships among the SQL commands but a check of the entities and relationships may still be performed before combining the entities and relationships for representation in a single ERD.

As noted above, the merging stage may be performed by an LLM 14 executed at server 104 or at cloud server 120, or the merging stage may alternatively be performed by merge module 18 at server 104. The dashed outline for merge module 18 indicates that some implementations may not include a separate merge module. For example, the merging of SQL commands, entity lists, visual markup language codes, or ERDs can be performed by one or more LLMs 14 instead of a separate merge module 18.

As shown in FIG. 1, DSDs 114 each include an interface 117 (i.e., interfaces 117A to 117N), a controller 116 (i.e., controllers 116A to 116N), and a storage device 118 (i.e., storage devices 118A to 118N) that stores portions of a database 10 or separate databases 10 (i.e., database portions or databases 10A to 10N). In some implementations, DSDs 114 can include, for example, a Hard Disk Drive (HDD) that includes rotating magnetic disk media as part of a storage device 118, a Solid-State Drive (SSD) that includes solid-state storage media as a part of a storage device 118, and/or a Solid-State Hybrid Drive (SSHD) that includes both solid-state media and rotating magnetic disk media as a part of a storage device 118.

Interfaces 117 of DSDs 114 can communicate with server 104 via a storage bus or storage network of storage system 100, which can include, for example, a CXL bus, PCIe bus, an NoC, a LAN, or a WAN, such as the internet or another type of bus or network. In this regard, interfaces 117 may include network interface cards in some implementations.

Controllers 116 of DSDs 114 can include, for example, one or more CPUs or other type of processors, microcontrollers, DSPs, ASICs, FPGAs, hard-wired logic, analog circuitry and/or a combination thereof that control operation of DSDs 114. In some implementations, controllers 116 can include an SoC that may be combined with one or more memories of a DSD 114 and/or an interface 117.

Those of ordinary skill in the art will appreciate with reference to the present disclosure that other implementations of FIG. 1 may differ. For example, other implementations may include multiple cloud servers 120 that may execute different LLMs 14 or portions of an LLM 14 for performing one or more stages of generating or updating an ERD for storage system 100. As another example variation, DSDs 114 may be connected to server 104 through network 130, as opposed to a dedicated storage bus or storage network as shown in FIG. 1.

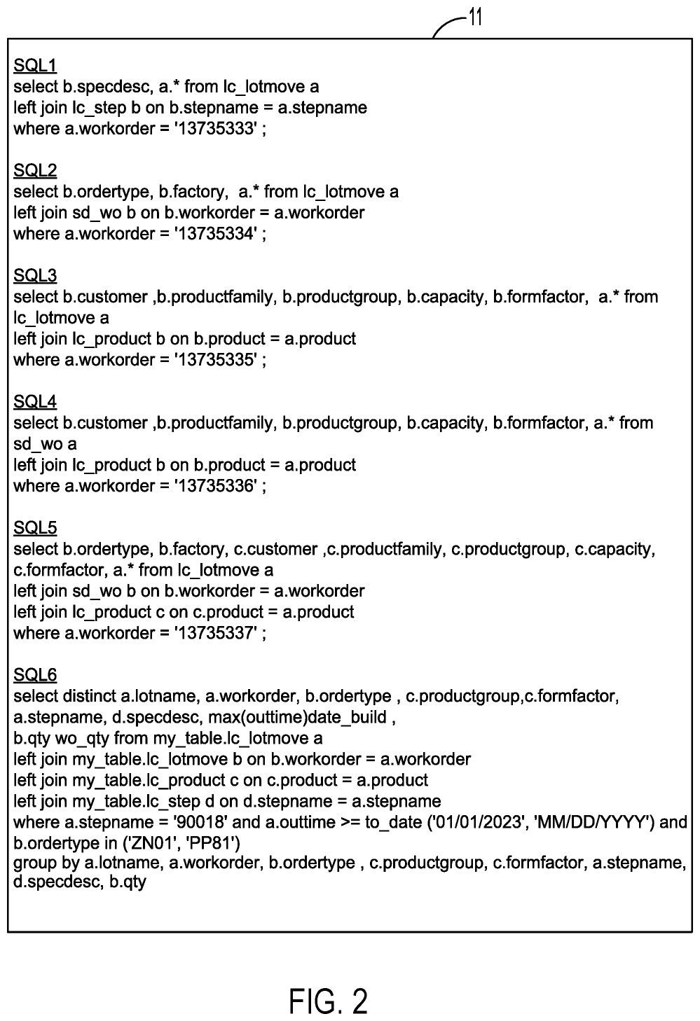

FIG. 2 is an example of SQL log 11 according to one or more embodiments. As shown in FIG. 2, six SQL commands, SQL1 to SQL 6, are stored in SQL log 11. The commands may be received by server 104 in FIG. 1 from one or more clients 101 accessing or modifying database(s) 10 stored at DSDs 114. In some implementations, log module 12 of server 104 may store SQL commands received from clients 101 and then filter the commands to select SQL commands for generating or updating an ERD that have been successfully performed and/or that include relationships between entities. The commands that have been successfully performed can include those, for example, that returned non-empty data to filter out commands that may have been for testing purposes or may have contained errors. In addition, the selection of commands that include at least one relationship between entities can filter out commands that may not be useful for generating or updating the ERD.

In this regard, each of SQL1 to SQL6 in FIG. 2 includes a relationship between entities and may also represent a filtered set of commands that were successfully performed. In some cases, server 104 may discard commands that were not successfully performed or returned a null value. In some implementations, server 104 may store received SQL commands for a period of time, such as for a day or for a week, before providing the commands or a filtered subset of the commands to an LLM 14 for identifying the entities, attributes, and relationships in the commands and/or translating the commands into a visual markup language code. In other implementations, the identification of entities, attributes, and relationships may be triggered by a storage space or buffer for SQL log 11 reaching a limit or by an input from a user of database system 105 for generating or updating an ERD. The filtering out of commands that do not include at least one relationship between entities may occur during the identification of entities, attributes, and relationships in some implementations.

Those of ordinary skill in the art will appreciate with reference to the present disclosure that other examples of SQL log 11 may vary from the example used in FIG. 2. In this regard, SQL log 11 may include many more SQL commands or may not have been filtered for commands that include relationships between entities to leave this filtering of commands to an LLM that identifies the entities, attributes, and relationships, if any, in the SQL commands of SQL log 11.

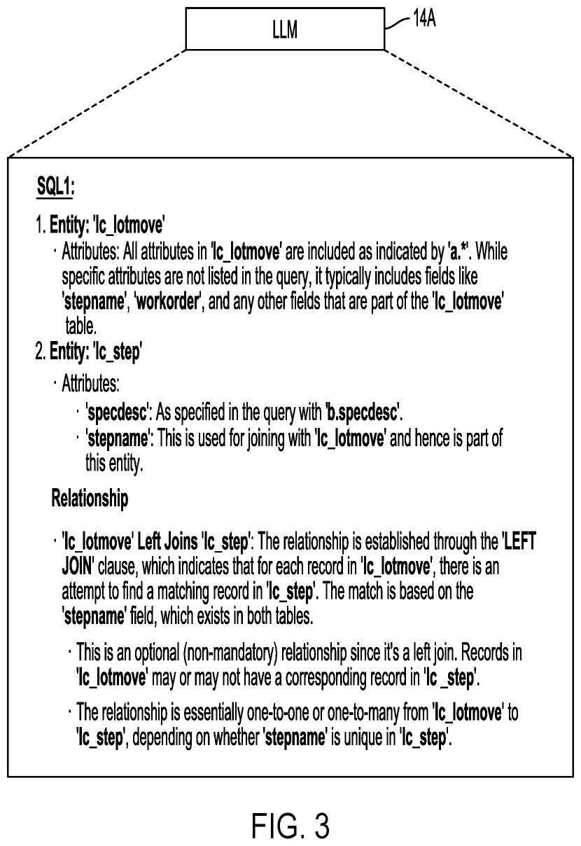

FIG. 3 illustrates the identification by LLM 14A of entities, attributes, and a relationship between the entities included in the SQL1 command of FIG. 2 according to one or more embodiments. In some implementations, the results shown in FIG. 3 may be in response to providing LLM 14A with the SQL1 command from SQL log 11 and a textual query to list the entities, attributes, and relationships for the command. In some cases, the textual query to LLM 14A may be generated by server 104 executing log module 12 and providing the commands from SQL log 11 as an input to the LLM.

As shown in FIG. 3, LLM 14A identifies two entities in SQL1-lc_lotmove and lc_step. The first entity, lc_lotmove, includes the attributes stepname and workorder, and the second entity, lc_step, includes the attributes specdesc and stepname. LLM 14A further identifies a relationship between the two entities based on the “LEFT JOIN” clause of SQL1. In some cases, LLM 14A may further identify other characteristics about the relationship between entities, such as whether it is a one-to-one relationship or a one-to-many relationship.

A similar identification of entities, attributes, and relationships can be performed by LLM 14A for other SQL commands in SQL log 11, such as for SQL commands 2 to 6. The identification of entities, attributes, and relationships by LLM 14A can be efficiently performed by an LLM that has been trained in the syntax of SQL commands. This identification of entities, attributes, and relationships by an LLM can greatly improve the performance of this stage of the generation or updating of an ERD in terms of speed and accuracy as compared to having a data engineer examine numerous SQL commands to identify entities, attributes, and relationships.

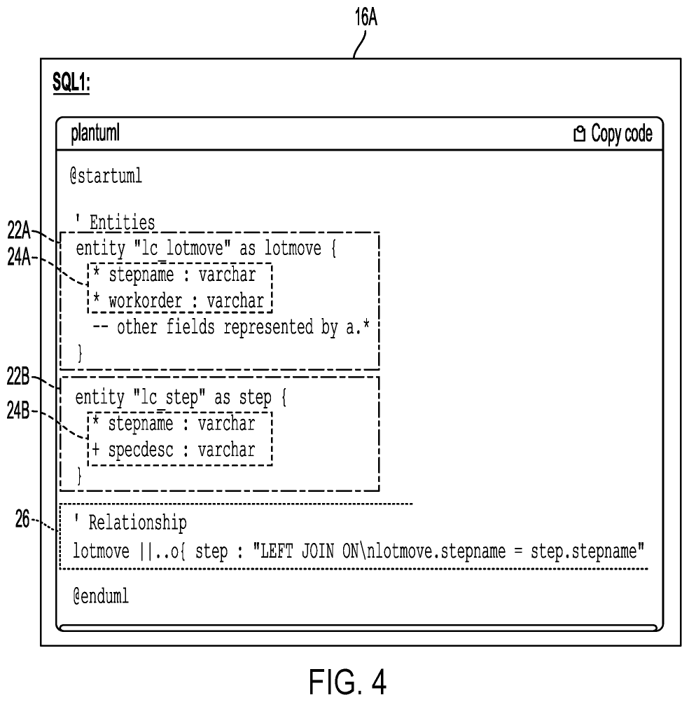

FIG. 4 is an example of SQL command SQL1 of FIGS. 2 and 3 translated into a visual markup language code according to one or more embodiments. As shown in FIG. 4, SQL1 has been translated into a PlantUML code based on the entities, attributes, and relationship identified by LLM 14A in FIG. 3.

In the example of FIG. 4, the first entity lc_lotmove is represented by the code in box 22A and includes the attributes of stepname and workorder in box 24A, which may correspond to columns in a table named lc_lotmove. The second entity, lc_step, is represented by the code in box 22B and includes attributes of stepname and specdesc in box 24B. The relationship between the two entities is shown in box 26.

In some implementations, a second LLM or a second LLM transformer may convert the entities, attributes, and relationships identified by a first LLM or by a first LLM transformer into the visual markup language code. In other implementations, a single LLM or LLM transformer may receive the SQL command as an input and a textual query to translate the SQL command into a visual markup language code, such as PlantUML.

In some implementations, each of the SQL commands provided to the LLM may be translated into separate visual markup language codes. In other implementations, the LLM may or merge module 18 of server 104 may first merge the entities, attributes, and relationships of the SQL commands in SQL log 11 before providing the merged entities, attributes, and relationships to the LLM to translate into the visual markup language code.

In merging the SQL commands, the merge module or LLM may start with a first command as a source list of entities, attributes, and relationships and then add any additional entries, attributes, and relationships from the source list to a destination list of entities, attributes, and relationships for a second command. This may then be repeated for the destination list, which becomes a new source list for adding additional (i.e., non-duplicate) entities, attributes, and relationships to a new destination list for a next SQL command in SQL log 11. After each command has been merged, a final list of the entities, attributes, and relationships from all of the SQL commands that are not duplicative can be used by an LLM to translate the final list into a PlantUML code for generating an ERD or updating an ERD.

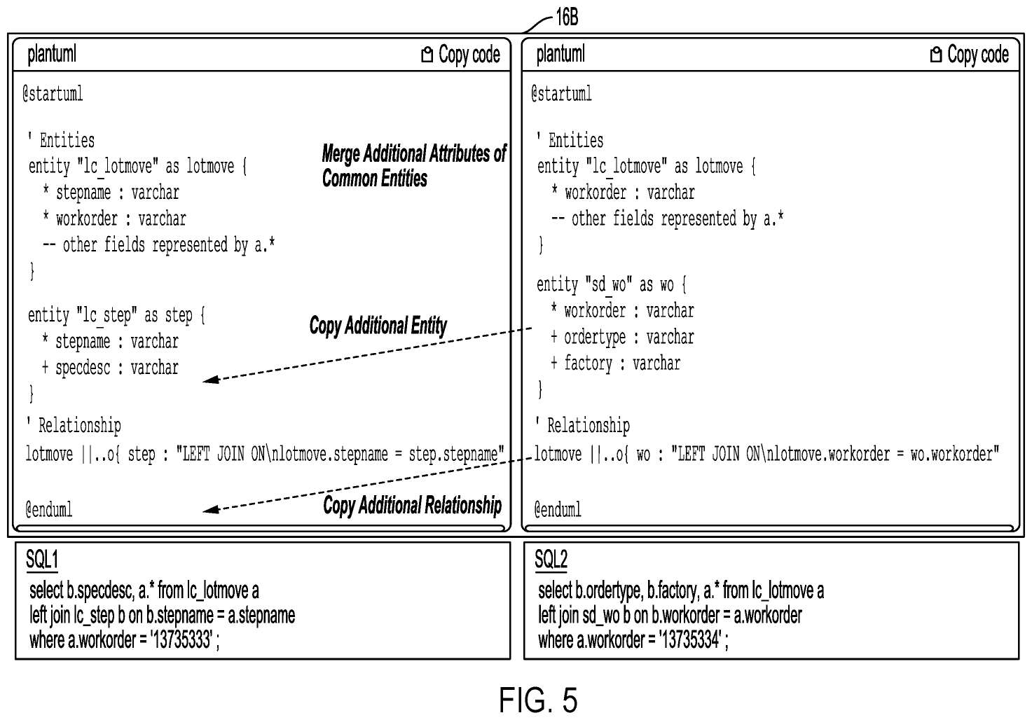

FIG. 5 is an example of the merging of two visual markup language codes 16B for two respective SQL commands according to one or more embodiments. In the example of FIG. 5, the PlantUML code for the SQL1 command is merged with the PlantUML code for the SQL2 command from SQL log 11 in FIG. 2. The commands are provided below their respective codes for reference with the SQL1 command and its code on the left half of FIG. 5 and the SQL2 command and its code on the right half of FIG. 5.

As shown in FIG. 5, the code for the SQL1 command may serve as a destination code and the code for the SQL2 command may serve as a source code. The attributes of entities that are common between the two codes are merged so that the lc_lotmove entity common to both the SQL1 and SQL2 commands includes the attributes of stepname and workorder. Since the entity sd_wo of the SQL2 command is not present in the SQL1 command, this additional entity is added or copied to the destination code so that three entities are represented in the merged destination code (i.e., lc_lotmove, lc_step, and sd_wo). In addition, the additional relationship to left join the entity sd_wo at the workorder column or attribute of the entity lc_lotmove is copied to the destination code so that two relationships are represented in the destination code.

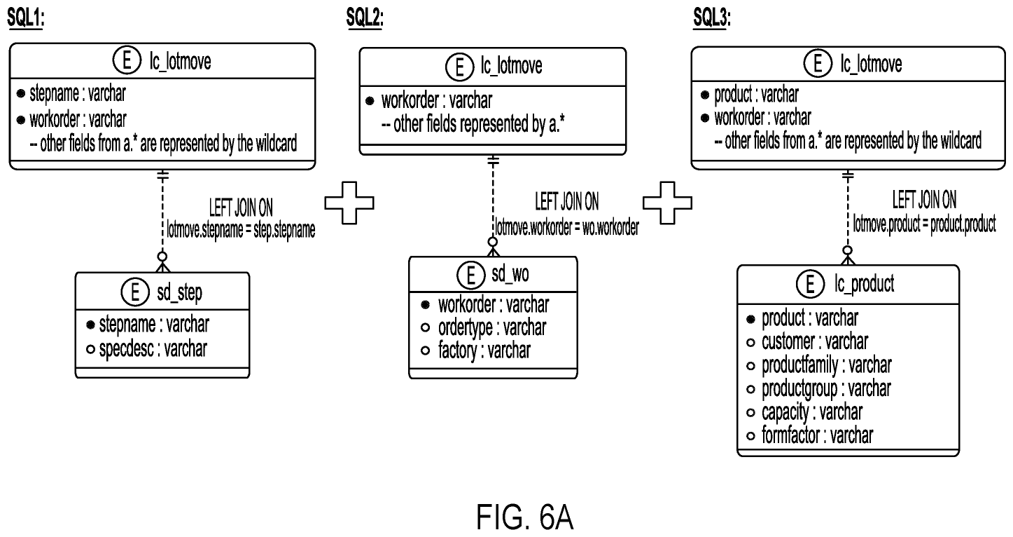

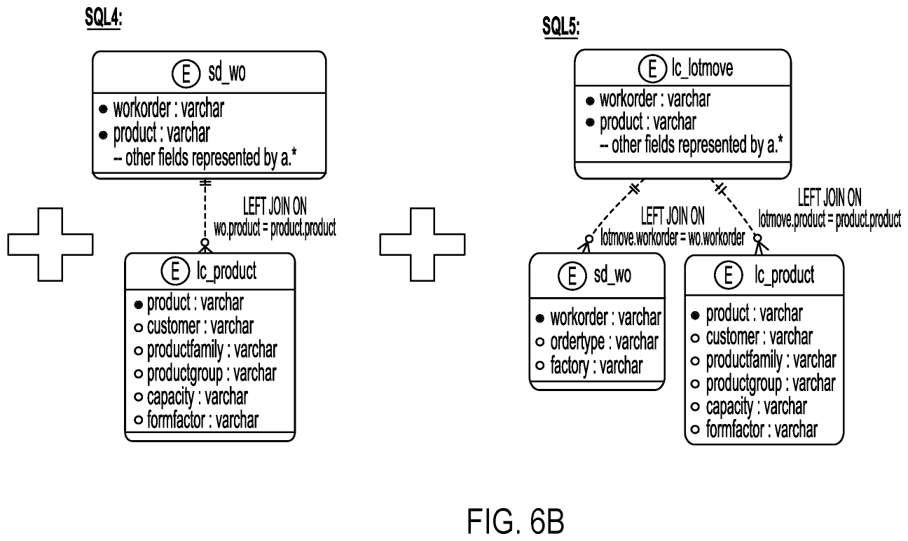

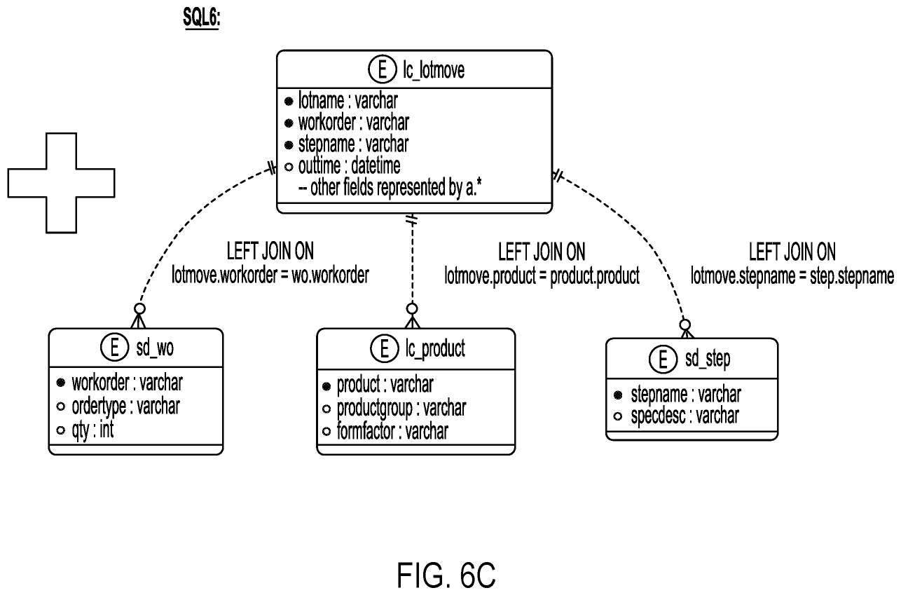

Those of ordinary skill in the art will appreciate with reference to the present disclosure that other implementations for merging visual markup language code for SQL commands may differ. For example, the SQL2 command may serve as the destination code and the SQL1 command may serve as the source code. As noted above, other implementations may instead merge the SQL commands into a final list of entities, attributes, and relationships before translating the final list into a merged visual markup language code. In other implementations, separate visual markup language codes for respective SQL commands may be used to generate separate ERDs that are then merged by an LLM or merge module 18. An example of the merging of separate ERDs is shown in FIGS. 6A to 6C discussed in more detail below.

FIGS. 6A, 6B, and 6C are the first, second, and third parts of an example illustrating the merging of the six SQL commands from SQL log 11 in FIG. 2 as represented by ERDs according to one or more embodiments. As shown in FIGS. 6A to FIG. 6C, the merging of only six SQL commands can become complicated and susceptible to error when attempting to merge the SQL commands or ERDs. Using an LLM or merge module 18 to merge SQL commands, visual markup language codes, or ERDs can be performed much quicker and with greater accuracy than manually merging commands, codes, or ERDs, especially for larger sets of commands that may include hundreds of SQL commands instead of only six SQL commands as in the example of FIGS. 6A to 6C.

Although the six SQL commands are represented with six separate ERDs in FIGS. 6A to 60, the merging of the commands can include merging lists of entities, attributes, and relationships or may include merging visual markup language codes for the six commands. However, in some implementations, the merging may actually include merging separate ERDs for the commands.

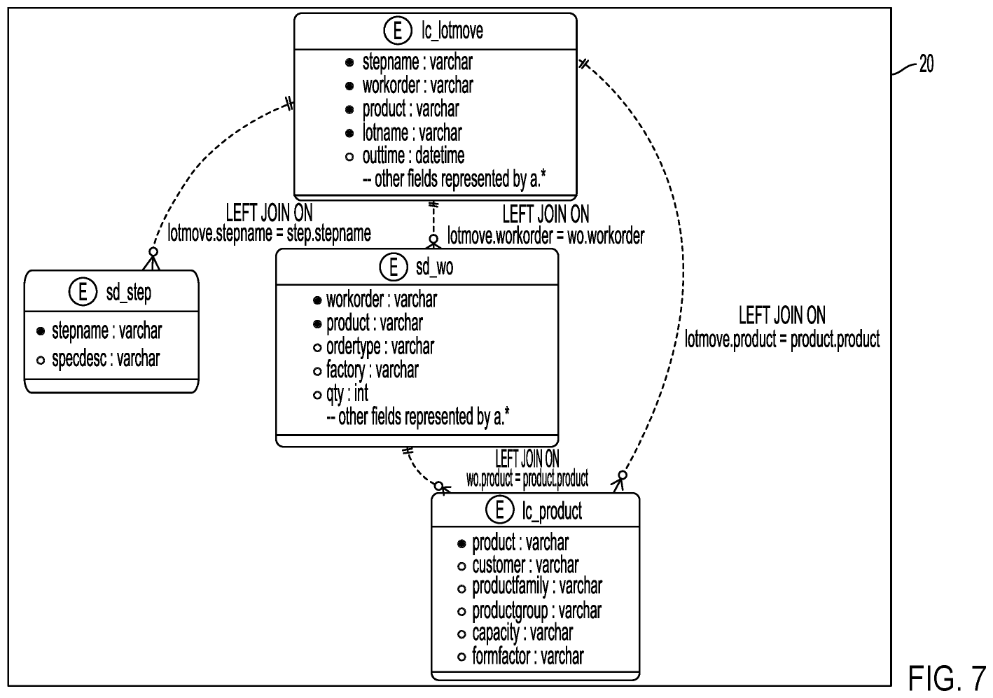

FIG. 7 is an example of a final ERD 20 after merging the six SQL commands from SQL log 11 in FIG. 2 according to one or more embodiments. In some implementations, an LLM may merge the six SQL commands, lists of identified entities, attributes, and relationships from the six SQL commands, visual markup language codes for the six SQL commands, or ERDs for the six SQL commands. In other implementations, a merge module may merge the six SQL commands, lists of identified entities, attributes, and relationships from the six SQL commands, visual markup language codes for the six SQL commands, or ERDs for the six SQL commands.

ERD 20 in the example of FIG. 7 provides an ERD that summarizes the relationships between the different entity relationships and attributes of the entities from the six SQL commands from SQL log 11 in FIG. 2. This ERD may be used to update a previously generated ERD for database(s) 10 in FIG. 1 based on previous SQL commands or may serve as an initial ERD for database(s) 10. In cases where ERD 20 in FIG. 7 is used to update a previously generated ERD, an LLM or merge module 18 may be used to consolidate the ERDs to represent an updated ERD for database(s) 10.

Since the ERDs for database(s) 10 may be automatically or periodically updated based on SQL commands received by server 104, the ERD for database(s) 10 can be used for helping users identify the relationships between data stored in database(s) 10 without requiring the effort and time to continually update the ERD.

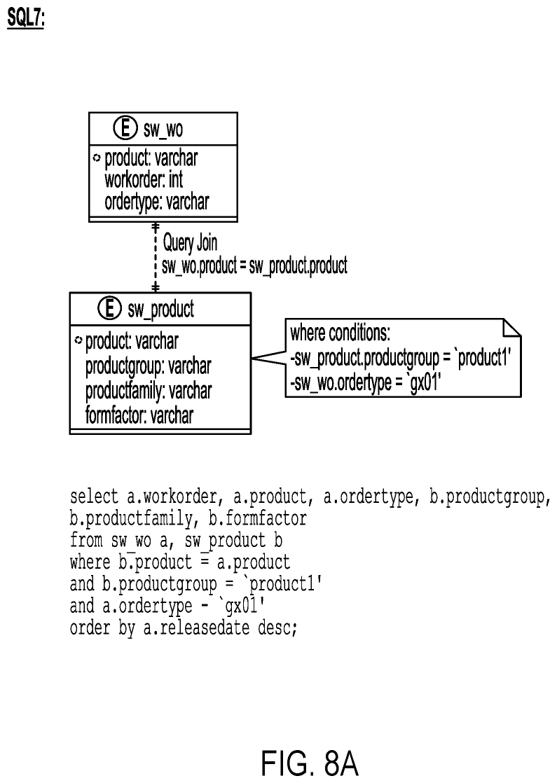

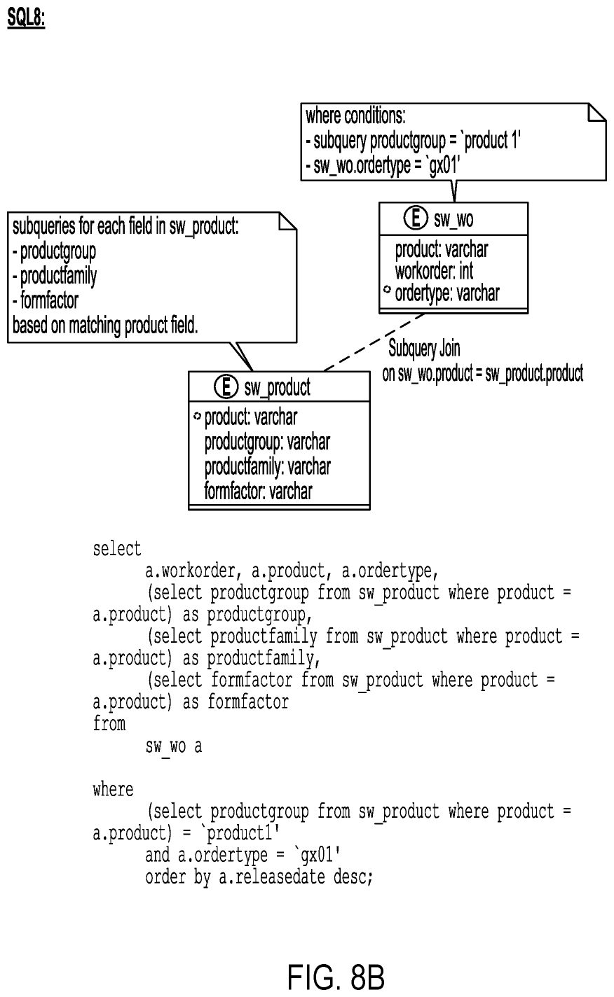

FIG. 8A is an example of a SQL query command labeled SQL7 that provides an entity relationship and is shown with a corresponding ERD according to one or more embodiments. Unlike SQL commands 1 to 6 discussed above, the SQL7 command of FIG. 8A does not use a join command to create a relationship between entities. Instead, the query command SQL7 provides a relationship between entities sw_wo and sw_product by specifying “where b.product=a.product.”

The ERD for command SQL7 shows this relationship with a dashed line between the sw_wo and sw_product entities and the indication of “Query Join” to indicate that the relationship is based on a query, rather than a direct join command, as with the Left Join commands discussed in the examples above. The indication of the relationship in the ERD further provides that the relationship is based on sw_wo.product=sw_product.product. An optional note is also added to the ERD to provide the filtering criteria applied to the productgroup and ordertype attributes. The ERD may be provided, for example, by server 104 in FIG. 1 based on visual markup language code generated by LLM 14 for the SQL7 command.

FIG. 8B is an example of a nested SQL query command labeled SQL8 that provides an entity relationship and is shown with a corresponding ERD according to one or more embodiments. As shown in FIG. 8B, the SQL8 command provides a relationship between entities sw_wo and sw_product with a subquery that joins the entities with “where product=a.product.”

The ERD for command SQL8 shows this relationship with a dashed line between the sw_wo and sw_product entities and the indication of “Subquery Join” to indicate that the relationship is based on a subquery, rather than a direct join command. The indication of the relationship in the ERD further provides that the relationship is based on “sw_wo.product =sw_product.product.” Optional notes are also added to the ERD to provide information on the subqueries and filtering criteria applied to productgroup and ordertype attributes. The ERD may be provided, for example, by server 104 based on visual markup language code generated by LLM 14 for the SQL8 command.

Those of ordinary skill in the art will appreciate with reference to the present disclosure that other entity relationships can be created with commands in addition to the join and query commands discussed above. In addition, other implementations may vary in the syntax of the SQL commands and/or the representations of ERDs for the commands. For example, other implementations of ERDs may use a line type such as a dashed line or a solid line to indicate a type of relationship, such as whether a relationship between entities is based on a direct relationship (e.g., a join command) or an indirect relationship (e.g., a query command).

### Example Processes

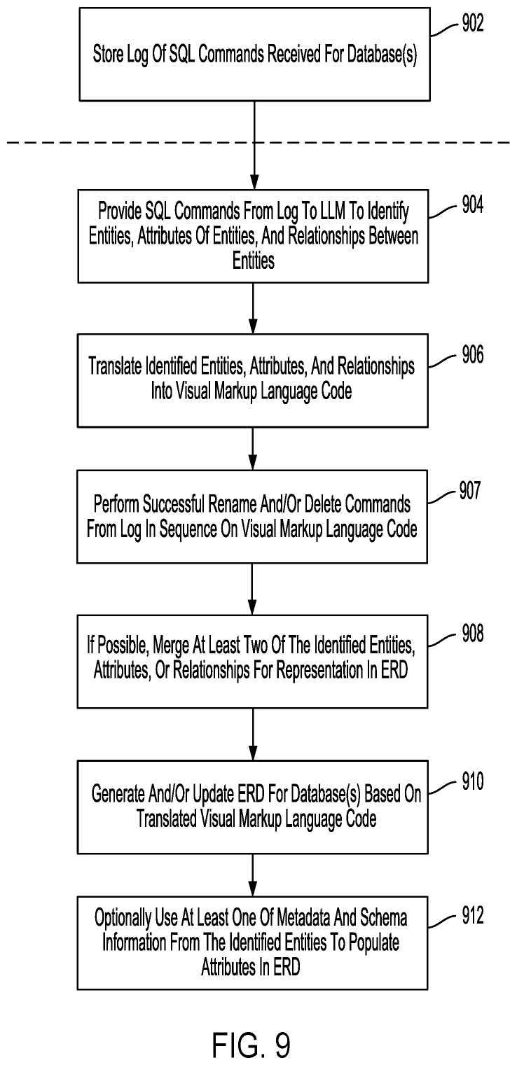

FIG. 9 is a flowchart for a database diagram process according to one or more embodiments. The process of FIG. 9 can be performed by, for example, one or more processors 108 of server 104 in FIG. 1 executing log module 12, one or more LLM(s) 14, and optionally, merge module 18. In other cases, the process of FIG. 9 may be performed partially by cloud server 120 in addition to one or more processors 108 of server 104 in FIG. 1. In this regard, processor(s) 108 and/or cloud server 120 can, in some implementations, comprise a means for performing the functions of the database diagram process of FIG. 9.

In block 902, a server for a database system (e.g., server 104 of database system 105 in FIG. 1) stores a log of SQL commands (e.g., SQL log 11 in FIG. 1) received for at least one database. The commands can come from one or more clients accessing the at least one database over a period of time, such as during a twenty four hour period or during a week. The commands can be stored in the log after performing the commands or receiving the commands in some implementations. In some cases, the server may filter the commands for storage in the log or for selecting a subset of commands from the commands in the log for identifying entities, attributes, and entity relationships. For example, the server may discard or not select commands that are not successfully performed and/or commands that do not include at least one relationship between two entities, which may be identified by the server based on the presence of particular clauses in the commands (e.g., a JOIN command) that associate entities.

In block 904, the server provides SQL commands from the log to an LLM to identify entities, attributes of the entities, and relationships between the entities included in the commands. The dashed line between blocks 902 and 904 in FIG. 9 indicates that the storage of SQL commands in the log may occur over a period of time well before the commands are provided at a later time to the LLM in block 904. For example, a time since last providing commands to the LLM may be used to trigger providing the commands in block 904 to the LLM, such as after twenty four hours or after a week since previously providing SQL commands from the log to the LLM. In other examples, a user input, the number of commands in the log, or the log reaching a threshold data size may trigger the commands being provided to the LLM. In some cases, the commands may be deleted from the log after providing them to the LLM to make room for new commands to be stored in the log.

In some implementations, the LLM may be locally executed by the server, such as with an LLM 14 in FIG. 1 executed at server 104. In other implementations, the server may provide the log or commands from the log to a cloud server, such as cloud server 120 in FIG. 1 that executes the LLM. In providing the commands to the LLM, the server may also provide a textual query requesting, for example, the identification of the entities, attributes, and relationships in the commands or the translation of the commands into visual markup language codes representing the commands.

In block 906, the entities, attributes, and relationships identified by the LLM are translated into a visual markup language, such as PlantUML. In some cases, the same LLM that identified the entities, attributes, and relationships may also translate the entities, attributes, and relationships into the visual markup language. In other implementations, a different LLM or a different LLM transformer may translate the entities, attributes, and relationships into the visual markup language. In addition, the server in some implementations may also provide an additional textual query requesting the translation of the entities, attributes, and relationships into the visual markup language.

In block 907, successful rename commands and/or delete commands from the log of commands are performed in sequence on the visual markup language code translated in block 906. The rename or delete commands can involve renaming or deleting entities or attributes of the commands represented by the translated visual markup language code. The commands are performed in sequence to ensure a correct representation of the current state of the one or more databases. In many cases, there may not be any successfully completed rename or deletion commands included in the log, and block 907 can be omitted. In other implementations, the performance of rename and/or deletion commands may instead occur after the identification of entities, attributes, and relationships in block 904 and before the translation of the identified entities, attributes, and relationships into the visual markup language in block 906. In such implementations, the changes from the performance of the rename and/or deletion commands can be made, for example, to a list of identified entities, attributes, and relationships from the commands in the log.

In block 908, at least two of the identified entities, attributes, or relationships are merged for representation in an ERD if there are any entities, attributes, or relationships that can be merged as may be the case when multiple SQL commands include the same entity. In some implementations, the merging may be performed by an LLM. In other implementations, the merging may be performed by a module executed by the server, such as merge module 18 in FIG. 1. The merging may be performed, for example, on separate lists of the entities, attributes, and relationships from one or more SQL commands, or on separate visual language markup language codes for one or more SQL commands translated in block 906. In some cases, block 908 may be omitted if there are no common entities or relationships among the commands to be merged.

In block 910, one or more processors of the server perform at least one of generating an ERD or updating an ERD for the at least one database based on the translated visual markup language code from block 906 or 908. In some implementations, one or more processors of the server can execute an editor or visualization engine for the visual markup language code to generate and/or update one or more ERDs or may access such an editor or visualization engine via a network to generate and/or update one or more ERDs based on the commands.

In some cases, a visual markup language code stored at the server, such as visual markup language code 16 in FIG. 1, may be updated using the translated visual markup language code from block 906 for the commands by merging the translated visual markup language code with the stored visual markup language code to generate an updated ERD that may be stored as ERD 20 in the example of FIG. 1. In other cases, a separate ERD may first be generated in block 910 for the commands and then the ERD generated for the commands may be merged with a previously stored ERD for the database(s) to update the ERD. As part of updating a previously constructed ERD for the database(s), rename commands and/or deletion commands from the log may first be performed in sequence on the previously constructed ERD or visual markup language code for the previously constructed ERD before merging with the translated visual markup language code for the commands in the log. In yet other cases, the ERD generated based on the commands may be the first ERD for the database(s) such that a stored ERD or visual markup language code is not updated in block 910.

In block 912, the server may optionally use at least one of metadata and schema information from the entities identified from the commands to populate attributes in the ERD generated or updated in block 910. The metadata or schema information may include comments or other documentation about the entities that may have been added by a user or creator of the entity to describe the data being stored in the entity or how the entity is structured. In this regard, information stored about the entities can be accessed by the server from the database(s) to, for example, add attributes to the ERD and/or visual markup language code that were not present in the commands to provide a more complete view of the attributes of the entities.

Those of ordinary skill in the art will appreciate with reference to the present disclosure that other implementations of the database diagram process of FIG. 9 may differ. For example, the merging of entities, attributes, or relationships in block 908 may instead occur after generating an ERD for the commands in block 910 by merging separate ERDs for one or more commands. As another example variation, the provision of the SQL commands to the LLM to identify entities, attributes, and relationships in block 904 may be combined with the translation of the entities, attributes, and relationships into visual markup language code in block 908 in that the LLM may identify the entities, attributes, and relationships in the commands as an initial part of translating the commands into visual markup language codes.

As another example variation, block 908 may be omitted in some implementations when there are no common entities or relationships to be merged from among the commands. In this regard, block 907 may be omitted in some implementations when there are no rename or deletion commands in the log. In addition, block 912 may be omitted in some implementations so that attributes are not added from metadata or schema information of entities in the database(s) outside of the attributes provided in the commands.

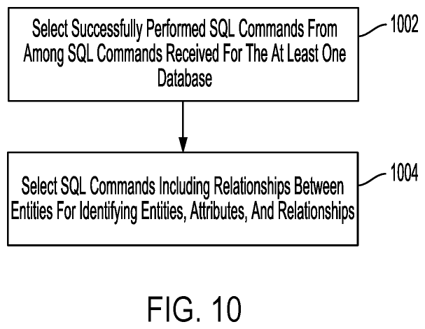

FIG. 10 is a flowchart for a log filtering process according to one or more embodiments. The process of FIG. 10 can be performed by, for example, one or more processors 108 of server 104 in FIG. 1 executing log module 12 and/or an LLM 14 or performed partially by cloud server 120 executing an LLM 14 in addition to one or more processors 108 of server 104 in FIG. 1. In this regard, processor(s) 108 and/or cloud server 120 can, in some implementations, comprise a means for performing the functions of the log filtering process of FIG. 10. The process of FIG. 10 may be performed in some implementations as a sub-process of a database diagram process, such as the database diagram process of FIG. 9 discussed above.

In block 1002, the server selects successfully performed SQL commands from among the SQL commands in the log. In this regard, the SQL commands may be added to the log as they are received by the storage system in some implementations, and then a subset of accumulated commands in the log can be selected for identifying entities, attributes, and relationships in the subset of commands.

The successfully performed commands can include, for example, commands that returned a value and/or did not return a null value or an error message. This filtering can prevent the use of commands that may not have been able to be implemented or may be used for testing from being used in generating an ERD for at least one database stored by the storage system. In some implementations, block 1002 may be performed before providing SQL commands to an LLM for identification of entities, attributes, and relationships from the commands. For example, a processor 108 of server 104 in FIG. 1 may filter an existing log of commands received for the at least one database for successfully performed commands before providing the filtered set of commands to an LLM 14 or to cloud server 120.

In block 1004, the server selects SQL commands from the commands stored in the log that include relationships between entities for identifying the entities, attributes, and relationships of the selected commands. The selection of the SQL commands that include relationships between entities can simplify the processing of the commands for representation in an ERD. In some cases, an LLM that identifies the entities, attributes, and relationships in the commands (e.g. an LLM 14 in FIG. 1 or an LLM executed by cloud server 120) can be used to discard commands that do not include relationships between the commands.

Those of ordinary skill in the art will appreciate with reference to the present disclosure that other implementations of the log filtering process of FIG. 10 may differ. For example, the selection of commands in blocks 1002 and 1004 may occur before adding the commands to the log, rather than filtering an existing log of commands. As another example variation, the order of blocks 1002 and 1004 may be reversed or performed simultaneously in some implementations. In yet other variations, one of blocks 1002 or 1004 may be omitted.

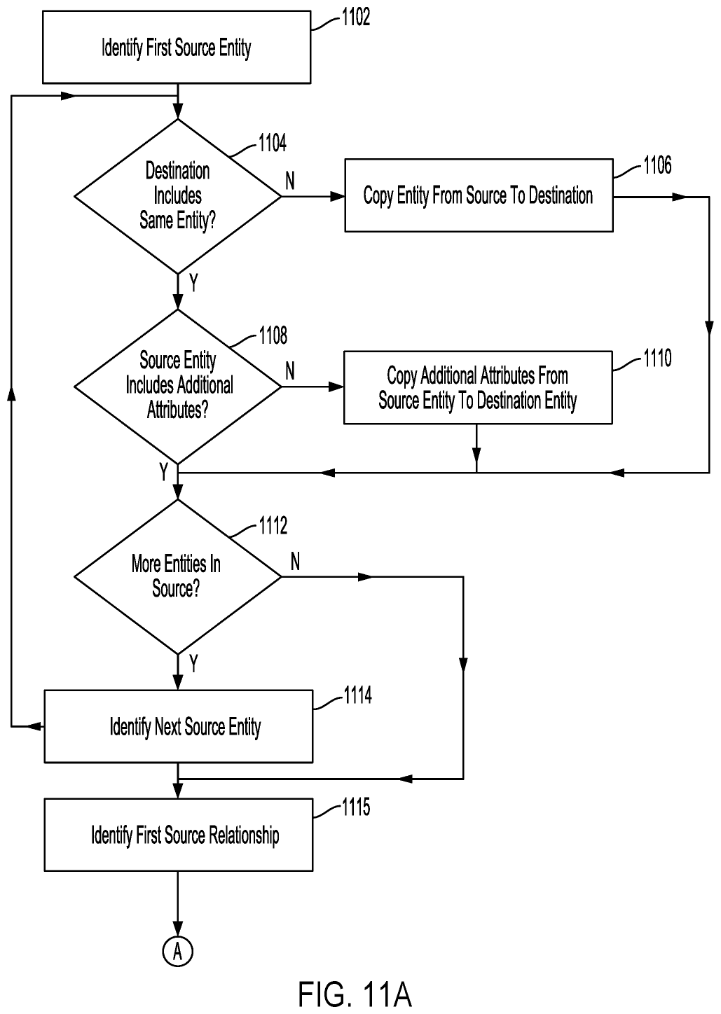

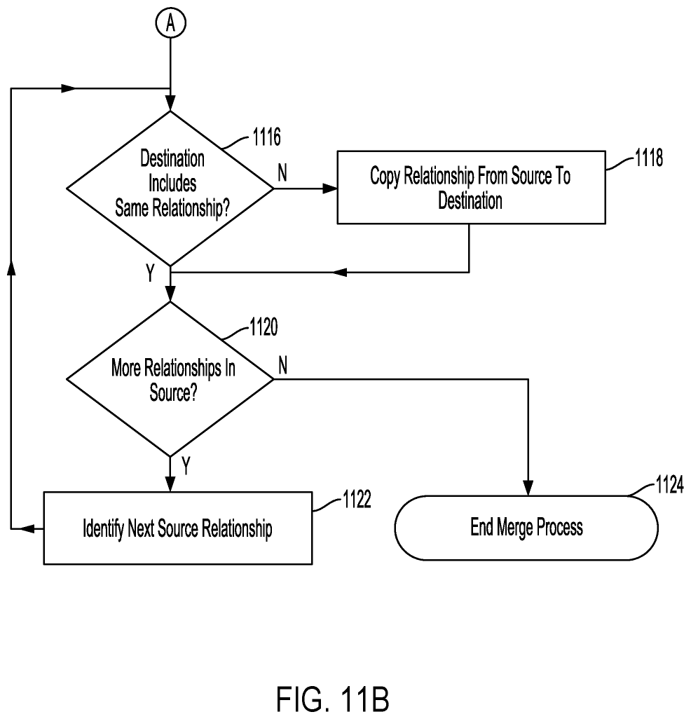

FIGS. 11A and 11B are different portions of a flowchart for a merge process according to one or more embodiments. The process of FIGS. 11A and 11B can be performed by, for example, one or more processors 108 of server 104 in FIG. 1 executing merge module 18. In this regard, processor(s) 108 can, in some implementations, comprise a means for performing the functions of the merge process of FIGS. 11A and 11B.

In block 1102, a first source entity is identified, such as by identifying an entity in a visual markup language code that has been translated from a SQL command. The translated visual markup language code can serve as a source to be merged with a destination that is another translated visual markup language code for a different SQL command. In other implementations, the source can include a source list of entities, attributes, and relationships from one or more SQL commands to be merged with a destination list of entities, attributes, and relationships from one or more other SQL commands.

In block 1104, the destination code or destination list is checked for the first source entity identified in block 1102. If the destination includes the same entity, it is determined in block 1108 whether the source entity includes additional attributes that are not in the matching entity in the destination. If so, the additional attributes are copied from the source entity to the destination entity in block 1110.

On the other hand, if it is determined in block 1104 that the destination does not include the source entity identified in block 1102, the entity is copied from the source to the destination in block 1106. The merge process continues in block 1112 to determine whether there are more entities in the source code or source list. If so, a next entity is identified in the source in block 1114 and the process returns to block 1104 to determine if the destination includes the same entity and check if there are additional attributes for matching entities to be copied from the source to the destination.

After all of the entities have been merged between the source and the destination, a first source relationship between entities in the source is identified in block 1115. In this regard, each of the source and the destination can include at least one relationship between entities. This may be due to the filtering of SQL commands to be used in the source and destination so that each has at least one relationship between entities.

The merge process continues in FIG. 11B with the determination as to whether the destination includes the same relationship identified in block 1116. If not, the relationship is copied from the source to the destination in block 1118. In block 1120, it is determined whether there are more relationships in the source code. If not, the merge process of FIGS. 11A and 11B ends in block 1124. If there is another relationship between entities in the source, the next source relationship is identified in block 1122 and the merge process returns to block 1116 to determine if the destination includes the same relationship.

Those of ordinary skill in the art will appreciate with reference to the present disclosure that other implementations of the merge process of FIGS. 11A and 11B may differ. For example, the identification of entities or relationships in other implementations may be performed in parallel such that all the entities in the source are compared to the entities in the destination or all the relationships in the source are compared to the all the relationships in the destination at the same time, rather than identifying one entity or one relationship at a time.

As discussed above, the foregoing systems and methods for generating and updating ERDs for databases can improve the visual documentation or diagraming of databases to save time in locating information or identifying relationships between data without requiring significant effort from domain experts. The foregoing systems and methods also enable periodic or continual updating of ERDs as the databases change without requiring additional notation or documentation of metadata and schema information for the changes, which is often neglected in database systems.

### Other Embodiments

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes processor or controller circuitry to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, processor circuitry, and controller circuitry described in connection with the examples disclosed herein may be implemented or performed with a general purpose processor, a GPU, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. Processor or controller circuitry may also be implemented as a combination of computing devices, e.g., a combination of a DSP and a microprocessor, a plurality of microprocessors, an SoC, one or more microprocessors in conjunction with a DSP core, or any other such configuration.

The activities of a method or process described in connection with the examples disclosed herein may be embodied directly in hardware, in a software module executed by processor or controller circuitry, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, an optical media, or any other form of storage medium known in the art. An exemplary storage medium is coupled to processor or controller circuitry such that the processor or controller circuitry can read information from, and write information to, the storage medium. In the alternative, the storage medium may be integral to processor or controller circuitry. The processor or controller circuitry and the storage medium may reside in an ASIC or an SoC.

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive. In addition, the use of language in the form of “at least one of A and B” in the following claims should be understood to mean “only A, only B, or both A and B.”

1. A database system, comprising:
at least one data storage device configured to store at least one database; and
one or more processors, individually or in combination, configured to:
receive a plurality of Structured Query Language (SQL) commands for the at least one database;
select, based on at least one criterion, SQL commands from among the plurality of SQL commands to use for at least one of generating and updating an Entity Relationship Diagram (ERD) for the at least one database;
identify, from the selected SQL commands, entities in the selected SQL commands, attributes of the entities, and relationships between the entities;
translate the identified entities, attributes, and relationships into a visual markup language code using a Large Language Model (LLM); and
perform at least one of generating and updating the ERD for the at least one database based on the visual markup language code.

2. The database system of claim 1, wherein the one or more processors, individually or in combination, are further configured to merge at least two of the identified entities, attributes, or relationships for representation in the ERD.

3. The database system of claim 2, wherein the one or more processors, individually or in combination, are further configured to use the LLM or another LLM to merge the at least two of the identified entities, attributes, or relationships.

4. The database system of claim 2, wherein the one or more processors, individually or in combination, are further configured to merge the at least two of the identified entities, attributes, or relationships before translating the identified entities, attributes, and relationships into the visual markup language code.

5. The database system of claim 1, wherein the one or more processors, individually or in combination, are further configured to provide the selected SQL commands from a log to the LLM or to another LLM to identify the entities, attributes, and relationships.

6. The database system of claim 1, wherein the one or more processors, individually or in combination, are further configured to:
store a log of SQL commands received for the at least one database including the plurality of SQL commands; and
identify the entities, the attributes of the entities, and the relationships between the entities from the selected SQL commands in response to at least one of a time since a last identification of entities, attributes, and relationships, a number of SQL commands being stored in the log, and an input from a user of the database system.

7. The database system of claim 1, wherein the one or more processors, individually or in combination, are further configured to:
store a log of SQL commands received for the at least one database; and
select successfully-performed SQL commands from among the SQL commands in the log to include in the selected SQL commands for identifying the entities, attributes, and relationships.

8. The database system of claim 1, wherein the one or more processors, individually or in combination, are further configured to:
store a log of SQL commands received for the at least one database; and
select SQL commands including relationships between the entities from among the SQL commands in the log to include in the selected SQL commands for identifying the entities, attributes, and relationships.

9. The database system of claim 1, wherein the one or more processors, individually or in combination, are further configured to use at least one of metadata and schema information from the identified entities to populate attributes for representation in the ERD.

10. A method for diagraming at least one database, the method comprising:
receiving a plurality of Structured Query Language (SQL) commands for the at least one database;
selecting, based on at least one criterion, SQL commands from among the plurality of SQL commands to use for at least one of generating and updating an Entity Relationship Diagram (ERD) for the at least one database;
providing the selected SQL commands to a Large Language Model (LLM) to identify entities in the selected SQL commands, attributes of the entities, and relationships between the entities;
translating the identified entities, attributes, and relationships into a visual markup language code; and
performing at least one of generating and updating the ERD for the at least one database based on the visual markup language code.

11. The method of claim 10, further comprising merging at least two of the identified entities, attributes, or relationships for representation in the ERD.

12. The method of claim 11, further comprising using the LLM or another LLM to merge the at least two of the identified entities, attributes, or relationships.

13. The method of claim 11, wherein merging the at least two of the identified entities, attributes, or relationships occurs after translating the identified entities, attributes, and relationships into the visual markup language code.

14. The method of claim 10, wherein translating the identified entities, attributes, and relationships into the visual markup language code is performed using the LLM or another LLM.

15. The method of claim 10, further comprising:
storing a log of SQL commands received for the at least one database; and
providing the selected SQL commands from the log to the LLM in response to at least one of a time since previously providing SQL commands to the LLM, a number of SQL commands being stored in the log, and an input from a user.

16. The method of claim 10, further comprising:
storing a log of SQL commands received for the at least one database; and
selecting successfully-performed SQL commands from among SQL commands in the log to include in the selected SQL commands to be provided to the LLM to identify the entities, attributes, and relationships.

17. The method of claim 10, further comprising:
storing a log of SQL commands received for the at least one database; and
selecting SQL commands including relationships between the entities from among the SQL commands in the log to include in the selected SQL commands to be provided to the LLM to identify the entities, attributes, and relationships.

18. The method of claim 10, further comprising using at least one of metadata and schema information from the identified entities to populate attributes for representation in the ERD.

19. A non-transitory computer readable medium storing computer-executable instructions, wherein when the computer-executable instructions are executed by one or more processors, the computer-executable instructions cause the one or more processors, individually or in combination, to:
receive a plurality of Structured Query Language (SQL) commands for at least one database;
select, based on at least one criterion, SQL commands from among the plurality of SQL commands to use for at least one of generating and updating an Entity Relationship Diagram (ERD) for the at least one database;
identify, from the selected SQL commands, entities in the selected SQL commands, attributes of the entities, and relationships between the entities;
translate the identified entities, attributes, and relationships into a visual markup language code using a Large Language Model (LLM); and
perform at least one of generating and updating the ERD for the at least one database based on the visual markup language code.

20. The non-transitory computer readable medium of claim 19, wherein when the computer-executable instructions are executed by the one or more processors, the computer-executable instructions further cause the one or more processors, individually or in combination, to merge at least two of the identified entities, attributes, or relationships for representation in the ERD.

21. The database system of claim 1, wherein the one or more processors, individually or in combination, are further configured to update the ERD by, at least in part, merging a previously-stored visual markup language code for the ERD with the visual markup language code.

22. The method of claim 10, further comprising updating the ERD by, at least in part, merging a previously-stored visual markup language code for the ERD with the visual markup language code.
